(19) United States
(12) Patent Application Publication
(10) Pub. No.: US 2006/0179885 A1
(43) Pub. Date: Aug. 17, 2006

(54) Method and apparatus for bending and tempering or heat-strengthening a bidirectionally curved glass panel

(76) Inventors: Pauli Reunamaki, Tampere (FI); Tamglass Ltd Oy, Tampere (FI); Peter Harjunen, Nokia (FI)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 10/545,792

(22) PCT Filed: Feb. 18, 2004
(86) PCT No.: PCT/FI04/50017

§ 371 Date: Feb. 17, 2006

(30) Foreign Application Priority Data
Feb. 21, 2003 (FI) 20035022

(51) Int. Cl. C03B 27/00; C03B 23/023

(52) U.S. Cl. 65/104; 65/106; 65/107; 65/114; 65/268; 65/287; 65/273; 65/348

(57) ABSTRACT

The invention relates to a method and apparatus for bending and tempering or heat-strengthening a bidirecdonally curved glass panel. A heated glass panel is curved in a main bending direction parallel to the advancing direction and in a sagging direction transversely to the advancing direction. Curving in the sagging direction is performed by bending conveyor rolls, the bending of which is effected by turning lever elements bearing-mounted for free rotation on the ends of the conveyor rolls. Between the outer ends of the lever elements is a push rod, whose length is quickly variable by means of an actuator.

The invention relates to a method for bending and tempering or heat-strengthening a bidirectionally curved glass panel, said method comprising:
heating a glass panel for bending and tempering or heat-strengthening
conveying the glass panel on top of horizontal conveyor rolls, said conveyor rolls constituting a bender
using the conveyor rolls of a bender to provide a bearing support for the substantially flat glass panel prior to bending
curving the heated glass panel in a main bending direction parallel to the advancing direction and in a sagging direction transversely to the advancing direction
subjecting the curved glass panel to a tempering or heat-strengthening cooling process.

The invention relates also to an apparatus for bending and tempering or heat-strengthening a bidirectionally curved glass panel, said apparatus comprising:
a heating furnace for heating glass panels to a bending temperature
a bending station for bending glass panels
horizontal conveyor rolls for conveying glass panels through the bending station
means for curving a roll conveyor constituted by the conveyor rolls within the bending station in the advancing direction or main bending direction of a glass panel,
means for bending glass panels presently in the bending station in a sagging direction transversely to the advancing direction, and
means for cooling a bent glass panel for tempering or heat-strengthening.

In the main bending direction, the glass panel has currently a typical radius of curvature of 900-3000 mm. In the sagging direction, the glass panel has currently a typical radius of curvature of 20000-40000 mm.

In prior known solutions, a glass panel is curved in the main bending direction by curving a row of rolls constituted by conveyor rolls. The Applicant's patent EP-261611 discloses one mechanism for curving a row of rolls in a bending-tempering station. Curving in the main bending direction can also be performed with an assembly described in the Applicant's published international application WO 02/074705.

In the process of bending a glass panel in two directions, it is prior known to curve the glass panel in a sagging direction by means of the following solutions:
twin rolls are used, one being concave and the other convex (patent publications U.S. Pat. No. 4,820,327 and U.S. Pat. No. 4,139,359)
rolls are bent at a plurality of support points and/or by deflecting in the middle (patent publications U.S. Pat. No. 6,363,753, U.S. Pat. No. 5,094,679 and U.S. Pat. No. 4,773,925)
a roll body is bent at the ends or the arc of a curved roll body is turned and the roll body is topped by a rotating “sleeve” (patent publications U.S. Pat. No. 4,586,946, U.S. Pat. No. 4,966,618, U.S. Pat. No. 4,557,745, U.S. Pat. No. 4,575,389 and EP-909742 B1)
Patent publication U.S. Pat. No. 4,226,608 discloses yet another solution for the bending of rolls by axial pressure applied to the ends.

A common feature in these prior known solutions is that the curvature or curving of a roll is permanent during production and only adjustable when no glass production is underway. The main reason for this is that, in these prior art solutions, changing the radius of curvature or bending radius of a roll is a tedious and inconvenient process or cannot be controlled to a sufficient precision during a dynamic bending process. The cited publications U.S. Pat. No. 4,557,745 and EP-909742 B1 propose elimination of this drawback by turning curved rolls for bringing the arc gradually from horizontal plane to vertical plane and for thereby gradually increasing transverse curvature. This type of roll structure is awkward because the roll must be topped by a rotating sleeve. Another drawback is that the advancing direction keeps changing and is indefinite over the length of a roll, because the circumference of a sleeve surrounding the roll is rotating in a plane which is substantially perpendicular to the roll.

It is an object of the invention to provide a method and apparatus, whereby a glass panel brought into a bending station in a flat condition can be curved in both curving directions, such that the radii of curvature of both curving directions gradually decrease.

This object is accomplished by a method of the invention on the basis of the characterizing features set forth in the appended claim 1. The apparatus has its characterizing features defined in the appended claim 8. The dependent claims disclose preferred embodiments for the invention. The inventive method and apparatus involve special features, such as:
1. The rolls of a bending means are in a flat condition upon the arrival of a glass element in a bending station.
2. When the glass element is substantially completely inside the bending station, the rolls are bent simultaneously such that the flexural moment and bending radius applied to the rolls are more or less constant over the entire length of the rolls. The own weight of a roll, the weight of a glass element, and the bending forces are the only factors that cause a slight deviation in an otherwise absolutely consistent radius.
3. During a bending process, every point of the roll bends at a substantially equal bending rate.
4. The bending means bends the rolls at a desired bending rate always precisely to a desired radius of curvature.

Two exemplary embodiments of the invention will now be described in more detail with reference to the accompanying drawings, in which

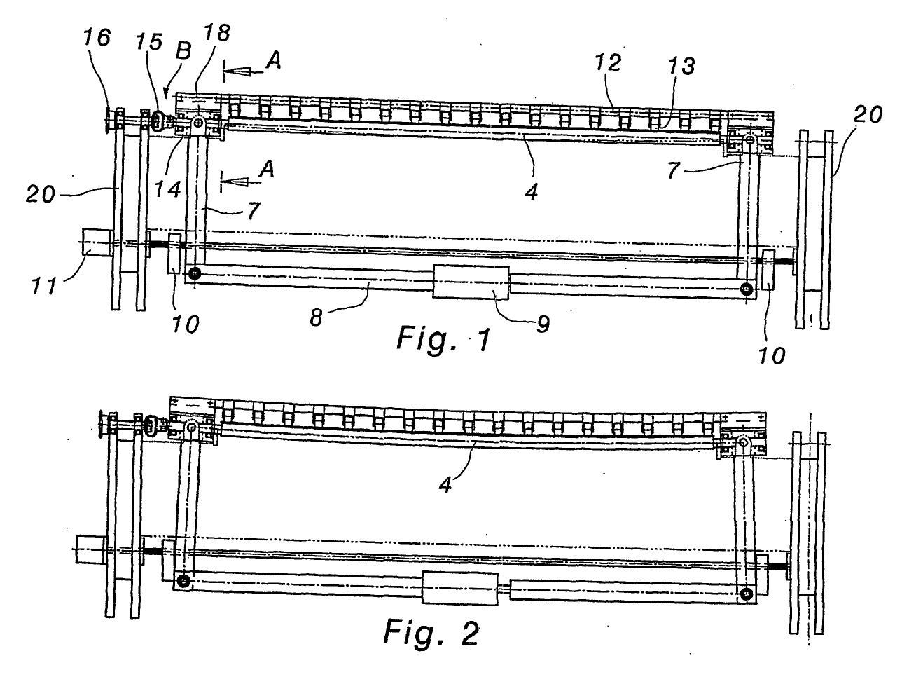

FIG. 1 shows a bending means according to a first embodiment of the invention prior to initiating a bending process as a flat glass panel has arrived on top of rectilinear rolls;

FIG. 2 shows the bending means of FIG. 1 at the end of a bending process with a glass element in a bent condition;

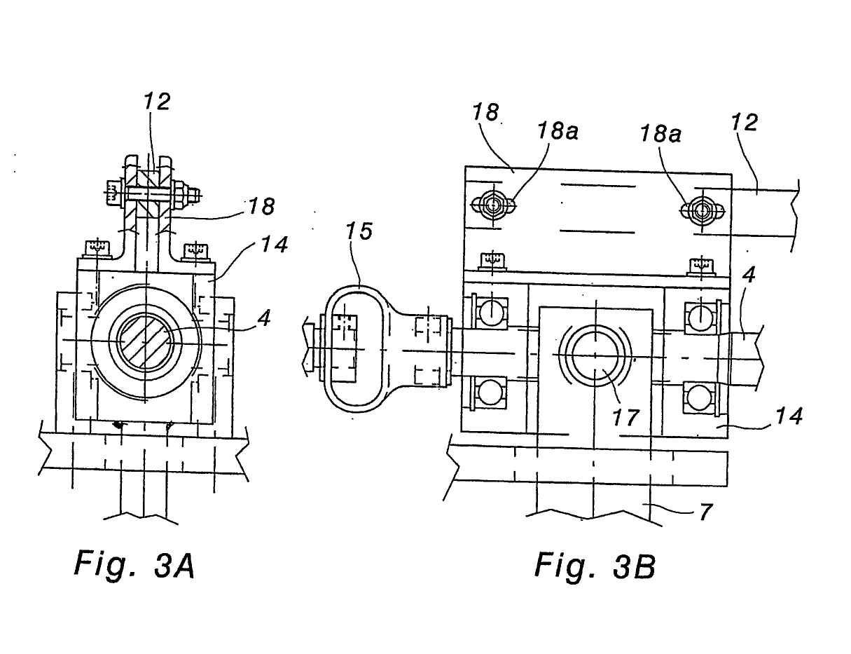

FIG. 3A shows a section along a line A-A in FIG. 1, in a larger scale;

FIG. 3B shows a detail indicated by an arrow B in FIG. 1, in a larger scale;

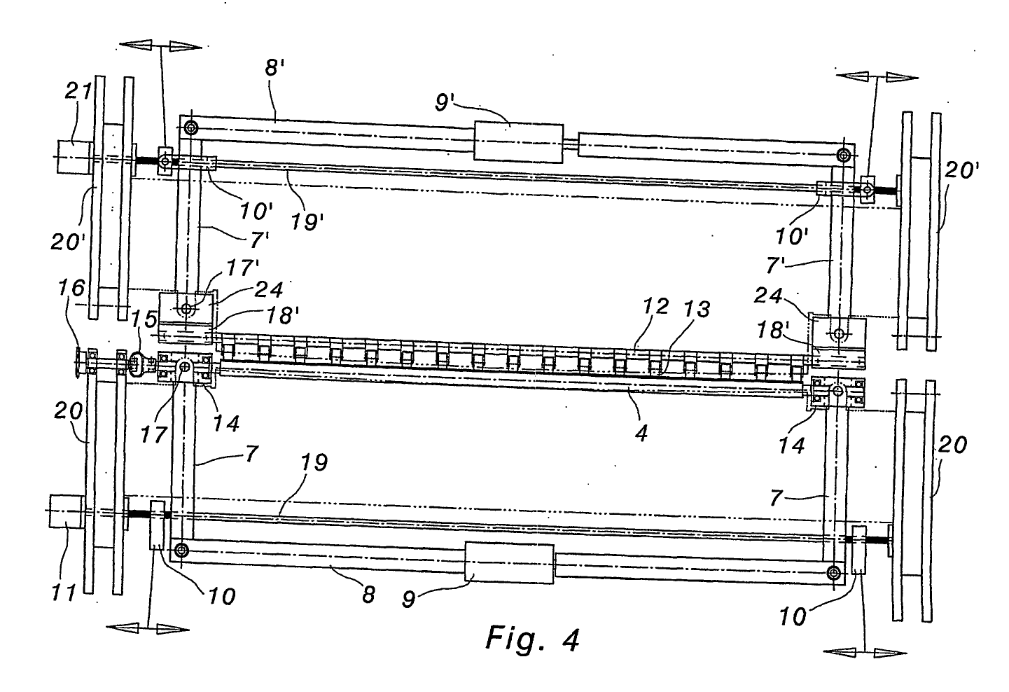

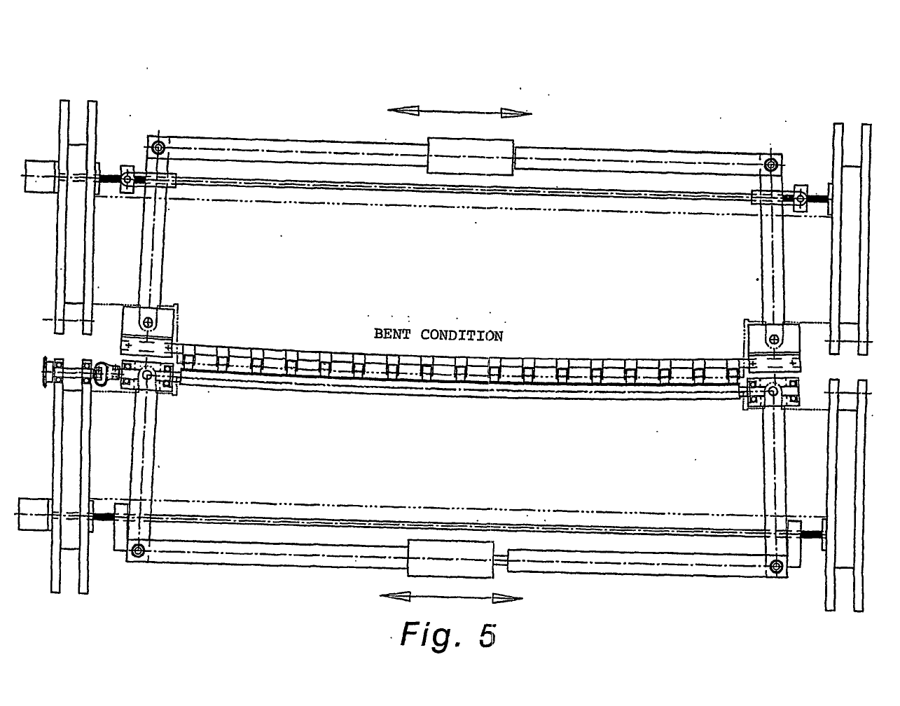

FIG. 4 shows a bending means according to a second embodiment of the invention at the start of a bending process with a flat glass panel on top of rectilinear rolls 4;

FIG. 5 shows the bending means of FIG. 4 at the end of a bending process with a glass element in a bent condition;

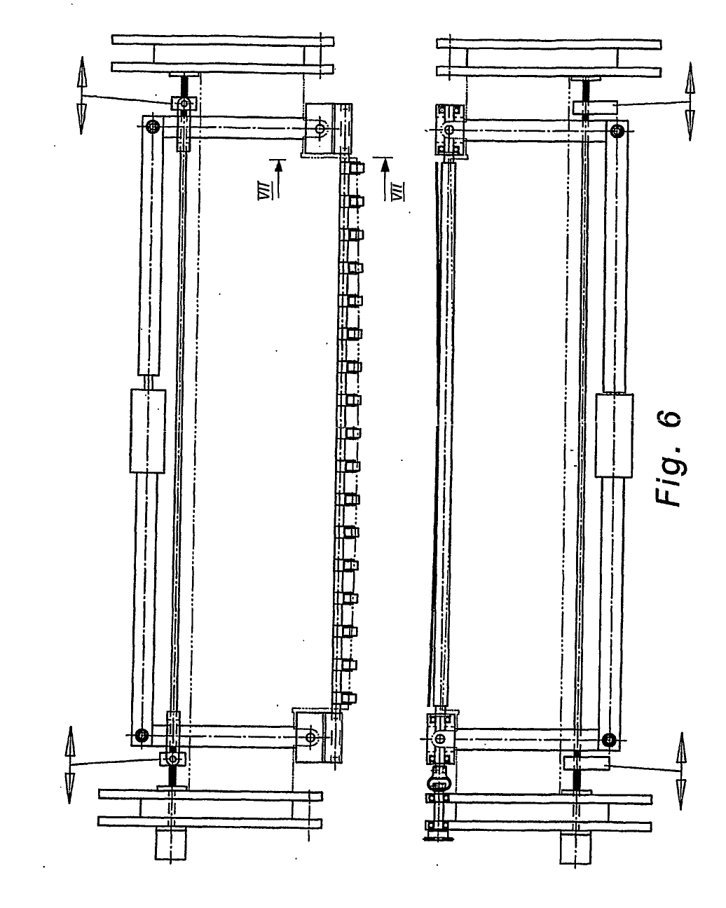

FIG. 6 shows the bending means of FIG. 4 after a tempering process as a bent and tempered glass element is ready to transfer out of the bending and tempering station;

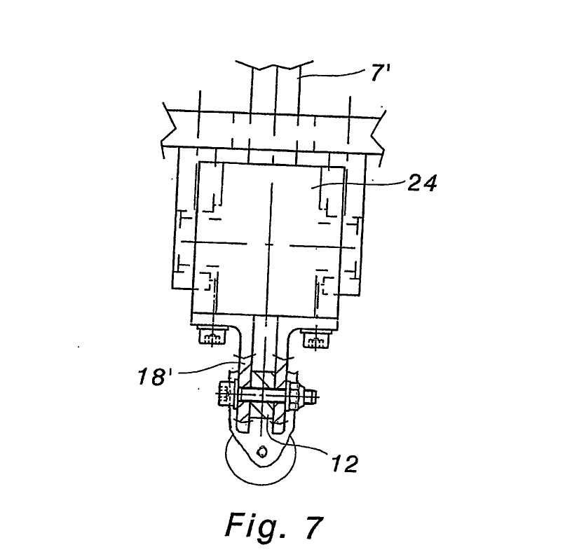

FIG. 7 shows a detail in a section along a line VII-VII in FIG. 6, in a larger scale;

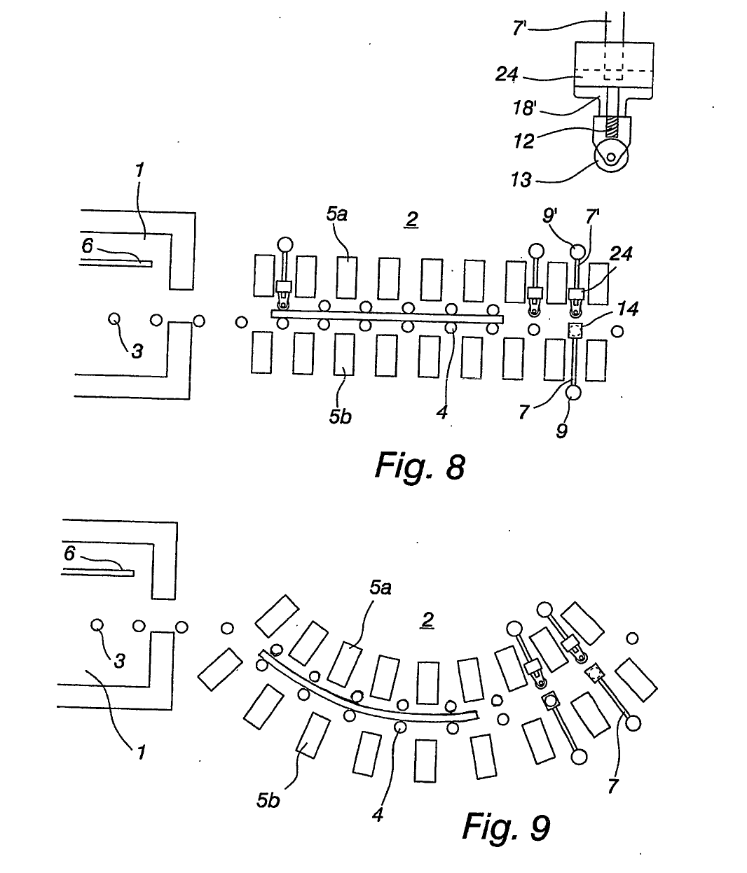

FIG. 8 shows schematically in a side view a bending and tempering station of the invention, which is provided with the bending means of FIGS. 4-7; and

FIG. 9 shows schematically the bending and tempering station of FIG. 8 at the end of a bending process. FIGS. 8 and 9 illustrate just some of the transverse bending devices, such devices being of course associated with every roll 4.

Regarding the invention, its novelty relates to the process of curving a glass panel in a direction transverse to the advancing direction, i.e. in a sagging direction.

FIGS. 1-3 depict an apparatus according to a first embodiment of the invention for curving a glass panel in a direction transverse to the advancing direction, i.e. in a sagging direction. The bending station's conveyor rolls 4 have both ends thereof provided with a lever element 7 bearing-mounted for free rotation. The end of each lever element 7 is provided with a bearing 14, which is rotated by the lever element 7 as it turns. The roll 4 has its end bearing-mounted to the bearing 14 such that, during its rotation, the bearing 14 applies a bending flexural moment to the roll 4. During a glass bending process, the curvature of the roll 4 is changed by bending the roll.

To the other end of the lever elements 7 is bearing-mounted a push rod 8 (which functions as a pull rod for convex bending). The push rod 8 has its length quickly variable by means of an actuator 9. A single actuator 9 can be adapted to bend two adjacent rolls 4. The actuator 9 may comprise e.g. a pneumatic cylinder capable of changing the length of the push rod 8 up to stoppers 10. The stoppers' position is adjustable e.g. by means of a threaded shaft rotated by a motor 11, the stopper 10 being mounted thereon. The actuator 9 may also comprise an electromechanical or hydraulic actuator. If the actuator 9 is a pneumatic cylinder, the curving can also be regulated simply by varying the cylinder's working pressure.

A rotary drive for the roll 4 from a sprocket 16 is transmitted by way of a flexible drive means 15, allowing slight movements for the end of a roll 4 both in axial direction and radial direction. A slight axial movement is necessary for the reason that, in the process of curving the rolls 4, the distance between the ends thereof becomes slightly smaller. Respectively, as the rolls undergo thermal expansion as a result of hot glass elements, the distance between the roll ends becomes slightly longer. The bearing assembly 14 is what is referred to as “floating”, which allows slight movements of the axle relative to a bearing house.

In the embodiment of FIGS. 1-3, the apparatus comprises also rows of press wheels, comprising press wheels 13 which are freely rotating. The press wheels 13 are mounted on a deflectable bar 12, having its ends connected to a fastening lug 18 by way of axial-play allowing attachments 18a, which lug is secured to the bearing element 14 of a roll end. Thus, the roll 4 and the bar 12 bend at the same time to the same degree. Hence, the rows of press wheels 13 are bent consistently with the rolls 4, such that the bending of a row of wheels 13 complies with that of the roll 4, thus maintaining a gap between the wheels' 13 bottom surface and the rolls' 4 top surface at least equal to the thickness of a glass element to be bent/tempered. The row of press wheels 13 can be replaced by another bendable roll, which is rotated synchronically with the lower roll 4.

The bending device of FIGS. 1-3 is only used in a glass bending process because the row of press wheels 13 is linked to a bending mechanism for the rolls 4. The bent glass element must be transferred for tempering in a separate tempering station downstream of the bending station.

Reference numeral 20 represents bending elements in a lengthwise bending means for bending a row of rolls 4 in a conventional manner in the conveying direction. The rolls 4 have their benders bearing-mounted to these bending elements 20.

If the bending means is used in an oscillating system, in which bending and tempering processes for a glass element are performed in a single station, the bending mechanisms for the rolls 4 and the upper wheels 3 are separate from each other, yet function on a common principle. This embodiment of the invention is illustrated in FIGS. 4-9. The bending of the roll 4 proceeds as described in reference to FIGS. 1-3. However, bending elements for a row (bar 12) constituted by the press wheels 13 are supported and suspended on actuators 20′ of the upper lengthwise bending means. The height of these upper lengthwise bending elements 20′ relative to the respective lower bending elements 20 can be adjusted in a stepless manner in order to provide between the press wheels 13 and the rolls 4 a suitable gap equal to the thickness of a glass element to be tempered.

The upper bending elements for lengthwise and crosswise curving can be lifted up after a tempering process for the removal of a glass element (FIG. 6).

FIGS. 4 and 8 represent a situation, wherein a glass element reaches a bender in the tempering station 2, said bender being flat both longitudinally and transversely.

FIGS. 5 and 9 represent a situation, wherein a glass element has been bent to form a sag (FIG. 5) and in a main bending direction parallel to the advancing direction (FIG. 9).

In FIG. 4, the same reference numerals are used for the components of bending means for the bar 12 consistent with those of the bending elements for the roll 4, but provided with inverted commas. The bearing element 14 transmitting a torque for the arm 7 has been replaced by a torsion element 24. The levers 7 and 7′ have their ends locked inside the elements 14 and 24 by means of a pin 17/17′. The torsion elements 24 are mounted on the fastening lugs 18′ for the ends of the deflectable bar 12. A pivotal movement of the arms 7′ is limited by internal stoppers 10′, whose position is adjusted by means of a motor 21.

FIGS. 8 and 9 further visualize upper cooling air boxes 5a and lower cooling air boxes 5b present in the bending and tempering station 2, which are associated with the lengthwise bending elements 20′ and 20 along which the rows of boxes 5a and 5b are curving. Thus, also the upper row of boxes 5a is liftable together with the bending elements 20′ and sagging elements associated therewith, as shown in FIG. 6. In addition, FIGS. 8 and 9 show schematically a downstream end of the heating furnace 1, the conveyor rolls 3 of a heating furnace, and heating elements 6 constituted e.g. by electric resistances. The heating furnace 1 can be of any conventional type.

1. A method for bending and tempering or heat-strengthening a bidirectionally curved glass panel, said method comprising:
heating a glass panel for bending and tempering or heat-strengthening
conveying the glass panel on top of horizontal conveyor rolls, said conveyor rolls constituting a bender
using the conveyor rolls of a bender to provide a bearing support for the substantially flat glass panel prior to bending
curving the heated glass panel in a main bending direction parallel to the advancing direction and in a sagging direction transversely to the advancing direction
subjecting the curved glass panel to a tempering or heat-strengthening cooling process,
wherein the curving in the sagging direction is performed by bending the conveyor rolls during a glass bending process, and that the conveyor rolls are bent by turning lever elements, to which the conveyor rolls ends are bearing-mounted for free rotation and which apply by way of said bearing assemblies a gradually increasing flexural moment to the rotating rolls.

2. A method as set forth in claim 1, wherein the curving of a glass panel in the advancing direction is performed such that every point of the glass panel is curved in this direction at a substantially equal curving rate, and that the curving of a glass panel in the sagging direction is also performed such that every point of the glass panel curves in the sagging direction at a substantially equal curving rate.

3. A method as set forth in claim 1, wherein the bending of a glass panel is assisted by freely rotating press wheels, which are mounted on a bar deflected in such a way that the bottom surfaces of the wheels mounted thereon form a radius of curvature which substantially matches that of the conveyor rolls (4) curving the glass panel in the sagging direction.

4. A method as set forth in claim 1, wherein the bending of a glass panel is assisted by upper press rolls, which are bent and rotated to the same degree as the conveyor rolls.

5. A method as set forth in claim 3, wherein the overall distance of the press wheels from the roll surface is adjusted according to glass thickness.

6. A method as set forth in claim 1, wherein the curving of a glass panel in both bending directions is started essentially simultaneously.

7. A method as set forth in claim 1, wherein the curving rate is arbitrarily and independently adjustable in both curving directions of a glass panel.

8. An apparatus for bending and tempering or heat-strengthening a bidirectionally curved glass panel, said apparatus comprising:
a heating furnace for heating glass panels to a bending temperature
a bending station for bending glass panels
horizontal conveyor rolls for conveying glass panels through the bending station
means for curving a roll conveyor constituted by the conveyor rolls within the bending station in the advancing direction or main bending direction of a glass panel,
means for bending glass panels presently in the bending station in a sagging direction transversely to the advancing direction, and
means for cooling a bent glass panel for tempering or heat-strengthening,
wherein the means for bending glass panels in the sagging direction comprise lever elements, which are bearing-mounted with bearings for free rotation to both ends of the conveyor rolls and which are associated with power units for bending the rolls by the application of a flexural moment provided by turning the lever elements while the conveyor rolls are rotating inside the lever elements' bearings.

9. An apparatus as set forth in claim 8, wherein between the other ends of the lever elements mounted on the opposite ends of the conveyor rolls is a push rod, which is provided with an actuator capable of quickly adjusting the length of the push rod.

10. An apparatus as set forth in claim 9, wherein the apparatus is provided with stopper elements for limiting a pivotal movement of the lever elements, and that the stopper elements' position is quickly adjustable by means of a motor drive.

11. An apparatus as set forth in claim 9, wherein the push rod functions as a pull rod for convex bending.

12. An apparatus as set forth in claim 8, wherein a single actuator is adapted to bend two adjacent rolls.

13. An apparatus as set forth in claim 8, wherein above the conveyor rolls are rows of press wheels, comprising press wheels which are freely rotating and mounted on a support bar which is deflectable to match a bending of the conveyor rolls, such that the deflection complies with that of the conveyor rolls, maintaining a gap between the wheels' bottom surface and the conveyor rolls' top surface equal to the thickness of a glass panel to be bent.

14. An apparatus as set forth in claim 8, wherein above the conveyor rolls are press rolls, which are provided with a rotary drive synchronized with the conveyor and which are deflectable to match a bending of the conveyor rolls, such that the deflection complies with that of the conveyor rolls, maintaining a gap between the press rolls' bottom surface and the conveyor rolls' top surface equal to the thickness of a glass panel to be bent.

15. An apparatus as set forth in claim 13, further comprising upper press wheels, wherein at least one of the deflectable support bar and the upper press wheels are adapted to be deflected with the bending means for the conveyor rolls or with a separate bending means, which is structurally and functionally similar to the conveyor rolls' bending means.

16. A method as set forth in claim 3, wherein the overall distance of the upper press rolls from the roll surface is adjusted according to glass thickness.

17. A method as set forth in claim 4, wherein the overall distance of the press wheels from the roll surface is adjusted according to glass thickness.

18. A method as set forth in claim 4, wherein the overall distance of the upper press rolls from the roll surface is adjusted according to glass thickness.
